(19) United States
(12) Patent Application Publication
(10) Pub. No.: US 2013/0304539 A1
(43) Pub. Date: Nov. 14, 2013

(54) User recommendation method and device

(71) Applicant: Alibaba Group Holding Limited, Grand Cayman (KY)

(72) Inventor: Dongyan Cheng, Hangzhou (CN)

(73) Assignee: Alibaba Group Holding Limited, Grand Cayman (KY)

(21) Appl. No.: 13/892,135

(22) Filed: May 10, 2013

(30) Foreign Application Priority Data
May 14, 2012 (CN) 201210149046.0

(51) Int. Cl. G06Q 30/02

(52) U.S. Cl. CPC G06Q 30/0201
USPC 705/7.29

(57) ABSTRACT

Techniques for user recommendation are described herein. These techniques include sorting, by a server, sellers from transaction records of buyers according to sequential orders associated with these transaction records. The server also creates transaction tracks for individual buyers, determines identical transaction tracks among transaction tracks of different buyers, and establishes associations among the sellers included in identical transaction tracks. Based on the associations, the server may make user recommendations. These techniques increase accuracy of associations among sellers as well as of user recommendation, and also save computing resources.

### CROSS REFERENCE TO RELATED PATENT APPLICATIONS

This application claims priority to Chinese Patent Application No. 201210149046.0, filed on May 14, 2012, entitled “A User Recommendation Method and Device,” which is hereby incorporated by reference in its entirety.

### TECHNICAL FIELD

This disclosure relates to communication technologies. More specifically, the disclosure relates to a user recommendation method and device.

### BACKGROUND

With rise of shopping websites, sellers can directly open online shops and sell their products without the high cost of setting up real stores, and buyers can directly purchase goods on the shopping websites. This has vastly increased efficiency of product transactions.

User recommendations are an effective way to increase the seller's trading volume on shopping websites. When the buyer clicks on a seller's webpage, in addition to providing the buyer with information on the seller's goods, the server can also provide the buyer with information on other sellers of products related to the original seller's goods.

For example, Seller A sells mobile phones with a brand name A, Seller B sells protective cases and skins for this brand name A mobile phone, and Seller C sells batteries, chargers, and headsets for brand name A mobile phone. When the buyer clicks on Seller As webpage, the server provides the buyer with product information for the brand name A mobile phone sold by Seller A, the server provides the buyer with information on Seller B and Seller C. In addition, the server recommends Seller B and Seller C to the buyer in order to make it easier for the buyer to go directly to the sites of Seller B and Seller C to choose accessories after the buyer orders brand name A mobile phone.

However, in existing technologies, relationships among sellers are found based on information submitted by sellers regarding types of sold goods. In addition, the seller-submitted information on the types of sold goods is provided by the sellers. Therefore, the information filled in by the seller regarding the type of goods being sold may not conform to the goods actually being sold. This can result in low accuracy of the associations among sellers found by the server and user recommendations, as well as wasting of computing resources.

### SUMMARY

The embodiments of this disclosure present a user recommendation method and device used to solve the problems with existing technologies of low accuracy in user recommendations and wasted processing resources.

The user recommendation method presented by the embodiments of this disclosure includes extracting, by a server, buyers' transaction records based on sequential orders in which the records in the transaction records were generated. The server may then sort the sellers extracted from every record, and determine transaction tracks including sorted sellers for the buyers.

The server may then compare the transaction tracks of different buyers, determine identical transaction tracks, and establishes associations among the sellers included in identical transaction tracks. Based on the associations, the server recommends sellers based on the associations among sellers.

The user recommendation device presented by the embodiments of this disclosure comprises a track determination module that is configured to extract buyer transaction records. The track determination module may, based on the sequential order in which the records in the transaction record were generated, sort the sellers from every record, and determine transaction tracks including the sorted sellers for the buyers.

In some embodiments, the device may include an association module that is configured to compare the transaction tracks of different buyers, find identical transaction tracks, and to establish associations among the sellers included in identical transaction tracks. The device may further include a user recommendation module that is configured to make user recommendations based on the associations among sellers.

The embodiments of this disclosure present a user recommendation method and device. This method sorts the sellers from every record according to the sequential order in which every record in the transaction record was generated, creates transaction tracks for the buyer, compares the transaction tracks of different buyers, determines identical transaction tracks, establishes associations among the sellers included in identical transaction tracks, and makes user recommendations based on the associations among sellers. Because identical transaction tracks for different buyers can indicate associability among different sellers in the actual transaction process, the server in the embodiments of this disclosure establishes associations for sellers based on identical tracks of different buyers. These embodiments can increase the accuracy of the associations among sellers established by the server, and can increase user recommendation accuracy and economize related processing resources.

This Summary is not intended to identify all key features or essential features of the claimed subject matter, nor is it intended to be used alone as an aid in determining the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 is a flow chart of implementing the process of user recommendation.

FIG. 2 is a diagram of buyer transaction tracks as presented by the embodiments of this disclosure.

FIG. 3 is a diagram of the user recommendation device presented by the embodiments of this disclosure.

### DETAILED DESCRIPTION

Suppose that products sold by Seller A are brand name A mobile phones, products sold by Seller B are brand name A mobile phone accessories, and products sold by Seller C are brand name B mobile phone accessories. If Seller B makes a mistake in filling out the information on the type of products they sell, brand name B mobile phone accessories is entered instead of brand name A mobile phone accessories. In addition, if Seller C makes a mistake in filling out the information on the type of products they sell, brand name A mobile phone accessories is entered instead of brand name B mobile phone accessories.

Accordingly, under existing technologies, the server would establish an association between Seller A and Seller C based on the product information submitted by the sellers, and therefore would not establish an association between Seller A and Seller B. Clearly, there should be an association between Seller A and Seller B, while there should not be an association between Seller A and Seller C. As results, the server would recommend information on Seller C, which is associated with Seller A, on the webpage when the buyer clicks on Seller A's webpage, while not presenting information on Seller B. This would reduce user recommendation accuracy and also waste computing resources.

In some embodiments, when a seller purchases multiple products, there is often a certain logic followed. For example, after a buyer purchases a brand name A mobile phone from Seller A, she may go to Seller B to purchase brand name A mobile phone accessories such as protective cases, protective sleeves, and chargers. Even if Seller B makes a mistake when filling in information on the types of products sold, the logic of the buyer does not change when purchasing products. Therefore, the embodiments of this disclosure introduce the concept of a transaction track, and include sorting the sellers of a buyer's previous transaction behaviors according to the chronological order of this buyer's transaction behavior and creating transaction tracks for this buyer. If a transaction track is identical to transaction tracks of different buyers, these buyers use the same or similar logic when purchasing products. The identical transaction tracks also indicate associability among the sellers included in the identical transaction tracks. Thus, the server establishes associations among the sellers included in identical transaction tracks and makes user recommendations based on this.

In combination with the Specifications' attached figures, the following provides a detailed description of the embodiments of this disclosure.

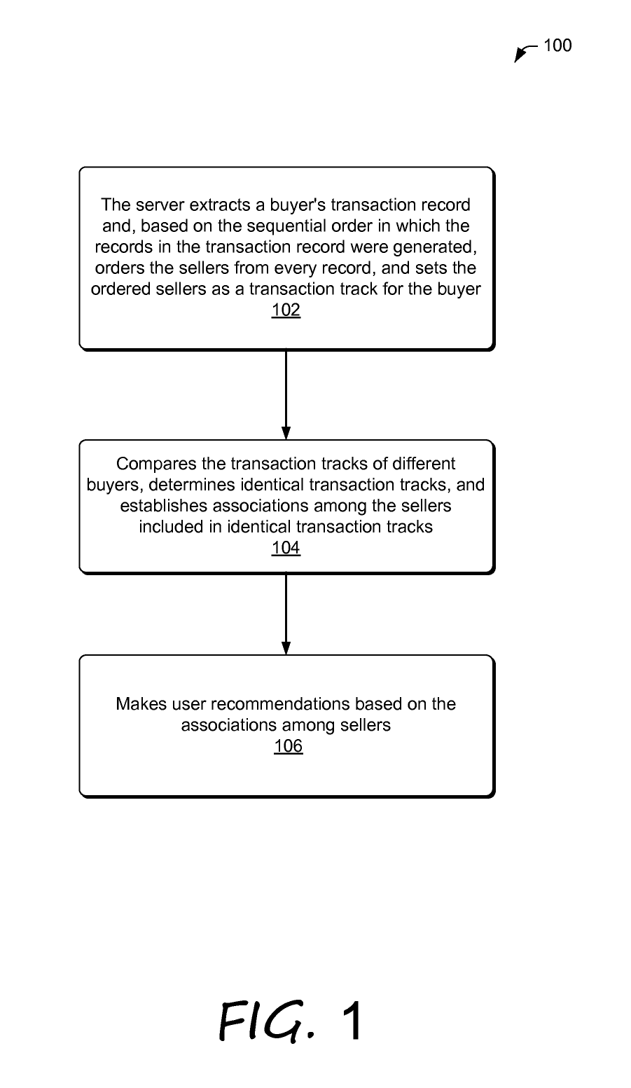

FIG. 1 is a flow chart of implementing the process of user recommendation. At 102, the server extracts a buyer's transaction record, and then sort the sellers from every record based on sequential order. The transaction records are generated based on the sequential order. The server also may determine the sorted sellers in a transaction track for the buyer.

In some embodiments, the server may store transaction records corresponding to every buyer. Every record in these transaction records includes information such as transaction behavior of the corresponding buyer, time of the transaction behavior, and sellers corresponding to the transaction behavior. Therefore, based on the buyer's transaction records, the server sorts the sellers from every record according to the sequential order of every record in the transaction records and creates a transaction track for that buyer. It is possible to extract the transaction records for a given buyer over a specified period of time, such as transaction records for the past 3 months.

As an example, there are 4 transaction records for Buyer 1, and the transaction track to Buyer 1 in these 4 records are Sellers 1˜4, indicating that Buyer 1 has conducted one transaction with each of the 4 Sellers 1˜4, for a total of 4 transactions. Based on the sequential order of these 4 records, Sellers 1˜4 are sorted as: Seller 1, Seller 2, Seller 3, and Seller 4. These 4 sorted sellers are in a transaction track for Buyer 1, indicating that Buyer 1 purchased products from Seller 1, Seller 2, Seller 3, and Seller 4, in such the order.

At 104, a comparison is made of the transaction tracks of different buyers, identical transaction tracks are determined, and associations among the sellers included in identical transaction tracks are established.

In some embodiments, after the server determines transaction tracks corresponding to different buyers using the method described at 102, the server compares the transaction tracks of different buyers and finds identical transaction tracks.

With respect to the example mentioned above, the transaction track for Buyer 2, determined by the server, is: Seller 1, Seller 2, Seller 3, and Seller 4; so the transaction tracks of Buyer 1 and Buyer 2 are identical. This means that when Buyer 1 and Buyer 2 were purchasing goods, they followed the same or similar logic, and that there is associability among Sellers 1˜4. Therefore, the server may establish associations among Sellers 1˜4.

In some embodiments, before the server establishes associations among the sellers included in identical transaction tracks, the server may assess a number of identical transaction tracks. When the number of identical transaction tracks is greater than a preset value, the server establishes associations among the sellers included in the identical transaction tracks.

Further with respect to the example mentioned above, the transaction tracks of both Buyer 1 and Buyer 2 are Seller 1, Seller 2, Seller 3, and Seller 4. Given the fact that there are only two identical transaction tracks, it might not be enough to suggest associability among these 4 sellers. Therefore, the server can assess whether or not a number of identical transaction tracks is greater than the preset number. In other words, the server may determine whether the number of buyers with this transaction track is greater than the preset value. Suppose that the server has determined transaction tracks for 100 buyers, and that the preset number is 10. The server assesses whether or not, of the 100 transaction tracks for these 100 buyers, there are more than 10 sharing this identical transaction track (Seller 1, Seller 2, Seller 3, Seller 4). In other words, the server assesses whether or not there are at least 11 buyers with this identical transaction track. If there are, there is sufficient evidence of associability among Sellers 1˜4, and the server may thus establish associations among Sellers 1˜4. Otherwise, the server does not establish associations among Sellers 1˜4.

At 106, the server may make user recommendations based on the associations among sellers. The server has established associations among sellers. Therefore, when making user recommendations, it can base them on the associations among sellers. More specifically, when presenting a seller's webpage, the server can present other sellers with associations to that seller on the webpage.

Further with respect to the example mentioned above, because associations among Sellers 1˜4 have already been established, Seller 2, Seller 3, and Seller 4 are presented as associated sellers on the webpage of Seller 1.

Using the method described above, the server establishes associations among the sellers included in buyers' identical transaction tracks because identical buyer transaction tracks can indicate associability among the sellers in the actual transaction process. Therefore, the user recommendation method presented by the embodiments of this disclosure can increase the accuracy of associations established among sellers, and thus increase user recommendation accuracy and economize related processing resources.

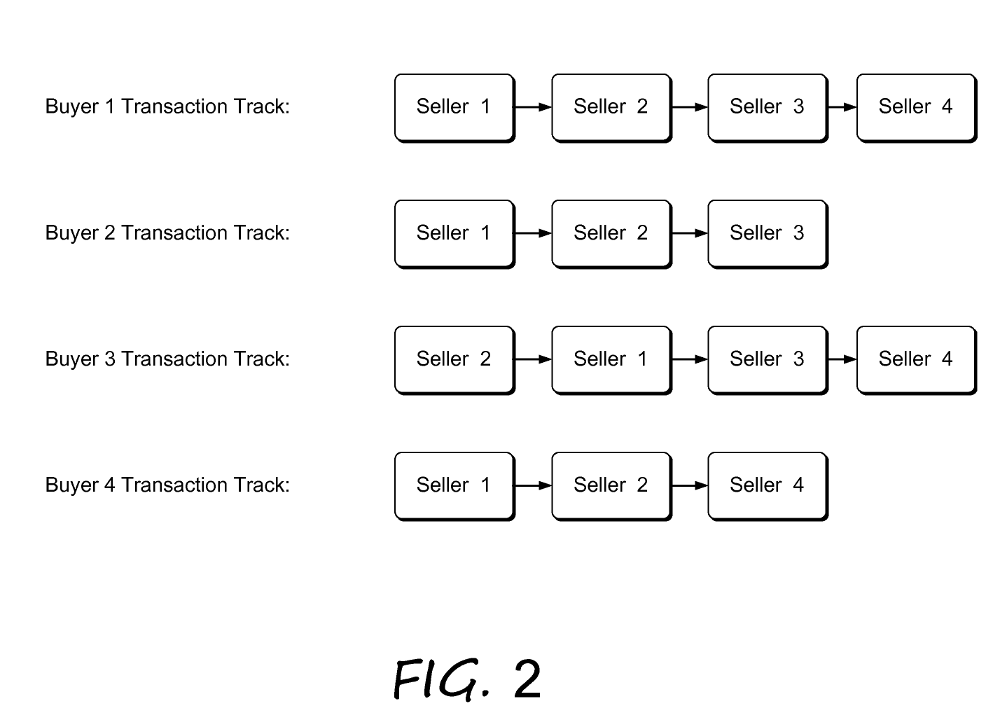

In some embodiments, given that different buyer have different demands, their logic in purchasing products might not be completely identical. Therefore, the probability of identical transaction tracks for different buyers as determined in operation 102 may not be high, which is discussed in detail in FIG. 2.

FIG. 2 is a diagram of buyer transaction tracks as presented by the embodiments of this disclosure. As illustrated in FIG. 2, the buyer transaction tracks determined according to operation 102 are as follows: Buyer 1 transaction track: Seller 1, Seller 2, Seller 3, Seller 4; Buyer 2 transaction track: Seller 1, Seller 2, Seller 3; Buyer 3 transaction track: Seller 2, Seller 1, Seller 3, Seller 4; Buyer 4 transaction track: Seller 1, Seller 2, Seller 4.

Here, even though the transaction tracks of these 4 buyers are similar, none are identical. These 4 transaction tracks show that there is clearly a certain degree of associability among Sellers 1˜4; but because these 4 transaction tracks are not identical, the server cannot find identical transaction tracks among these 4 transaction tracks and cannot establish associations among Sellers 1˜4. This would lead to a decrease in accuracy of the associations established among sellers and a decrease in accuracy of user recommendations.

Therefore, in order to further increase the accuracy of the associations established among sellers and further increase the accuracy of user recommendations, the specific method of determining buyer transaction tracks in the embodiments of this disclosure is discussed as follows. The sellers recorded in each record for a given buyer are sorted according to the sequential order in which the records in the buyer's transaction record were generated. Based on the sorted sellers, a setting method is used to determine tracks, and all of the different tracks that can be determined using this setting method are viewed as transaction tracks for this buyer. Here, the specific setting method used to determine tracks includes randomly extracting two sellers from the ordered sellers. These two sellers are sorted according to their ordering sequence among the ordered sellers, and then the two sorted sellers are determined as a transaction track.

Therefore, any potential situations for two sellers randomly extracted from the ordered sellers may be run through. In individual situations, the two randomly extracted sellers are sorted according to their ordering sequence among the sorted sellers, and the two sorted sellers are determined as a transaction track for the buyer.

In the embodiment shown in FIG. 2, with regard to Buyer 1, the sorted sellers are: Seller 1, Seller 2, Seller 3, Seller 4. Two sellers are randomly extracted from among these 4 sellers. Suppose that that they are Seller 1 and Seller 2. The initial order for these two sellers is first Seller 1, and then Seller 2. Therefore, these two sellers are sorted as follows, based on this ordering sequence: Seller 1, Seller 2. Thus, a transaction track for Buyer 1 is: Seller 1, Seller 2, notated as L12.

Further, with respect to Buyer 1, suppose that Seller 1 and Seller 3 are randomly extracted. The initial order for these two sellers is first Seller 1, and then Seller 3. Therefore, these two sellers are sorted as follows, based on this ordering sequence: Seller 1, Seller 3. Thus, another transaction track for Buyer 1 is: Seller 1, Seller 3, notated as L13.

Similarly, a total of 6 transaction tracks can be determined for Buyer 1: L12, L13, L14, L23, L24, L34. Accordingly, with respect to Buyer 2, a total of 3 transaction tracks can be determined: L12, L13, L23. For Buyer 3, a total of 6 transaction tracks can be determined: L21, L23, L24, L13, L14, L34. For Buyer 4, a total of 3 transaction tracks can be determined: L12, L14, L24.

Here, a total of 18 transaction tracks can be determined for Buyers 1˜4, and every transaction track includes two sellers. Thus, in operation 104, the method for finding identical transaction tracks is as follows. With respect to two transaction tracks, if the buyers included in one transaction track are identical to the sellers in another transaction track. In addition, when the sorting sequences of the sellers in both transaction records are identical, these two transaction tracks are determined to be identical.

Further with respect to the example mentioned above, of the 18 transaction tracks found for Buyers 1˜4, L12 and L21 are two non-identical transaction tracks. This is because, even though both transaction tracks include Seller 1 and Seller 2, the ordering sequences of Seller 1 and Seller 2 in the two transaction tracks are not identical.

Using this method to find identical transaction tracks, the identical transaction tracks found among these 18 transaction tracks are: L12 (three tracks), L13 (three tracks), L14 (three tracks), L23 (three tracks), L24 (three tracks), and L34 (two tracks). Suppose that the preset number is 2. In this case, the number of buyers sharing transaction track L34 (Buyer 1 and Buyer 3) is not greater than the preset number; so an association between Seller 3 and Seller 4 is not established. For transaction tracks L12, L13, L14, L23, and L24, each has 3 buyers sharing these tracks, which is greater than the preset number 2. Therefore, associations are established between Seller 1 and Seller 2 (included in transaction track L12), Seller 1 and Seller 3 (included in transaction track L13), Seller 1 and Seller 4 (included in transaction track L14), Seller 2 and Seller 3 (included in transaction track L23), and Seller 2 and Seller 4 (included in transaction track L24).

In some embodiments, the server may make user recommendations based on the established associations. For example, when the webpage of Seller 1 is presented, Seller 2, Seller 3, and Seller 4 that are associated with Seller 1 are presented on the page. When the webpage of Seller 3 is presented, Seller 1 and Seller 2, which are associated with Seller 3, are presented on the page, but not Seller 4. When the webpage of Seller 4 is presented, Seller 1 and Seller 2 are also presented on the page, but not Seller 3 because there is not an association between Seller 3 and Seller 4.

In some embodiments, after an identical transaction track has been found, when establishing associations among the sellers included in this identical transaction track, the directionality of the transaction track may be taken into consideration. When purchasing products has a certain degree of directionality in certain scenarios, this direction is unidirectional, not bidirectional. If the directionality of the transaction track is not taken into consideration, contradictions may occur when establishing associations among sellers.

For example, a buyer purchases brand name A mobile phone from Seller 1, then purchases brand name A mobile phone protective case from Seller 2. Therefore, the transaction track for this buyer is: Seller 1, and Seller 2. The purchasing logic of this buyer indicates that the buyer purchased brand name A mobile phone, and then wanted to purchase brand name A mobile phone protective case. If the number of buyers sharing this transaction track is greater than the preset number, an association between Seller 1 and Seller 2 can be established. In some embodiments, the majority of buyers use this logic when purchasing products. However, if this logic is reversed, the inverted logic indicates the buyer purchased brand name A mobile phone protective case, and then wanted to purchase brand name A mobile phone. Clearly, only a small number of buyers would use this inverted logic, and the transaction track for this small number of buyers would be: Seller 2, Seller 1. If the number of buyers using this inverted logic is not greater than the preset number, the number of buyers sharing this “Seller 2, Seller 1” transaction track would not be greater than the preset number. Therefore, an association between Seller 2 and Seller 1 should not be established. This may cause contradictions.

Therefore, in order to further increase the accuracy of the associations among sellers, in some embodiments, the method of establishing associations among two sellers included in an identical transaction track is as follows. A unidirectional association is established among the sellers included in an identical transaction track, and this unidirectional association is the association from the seller coming first in the order toward the seller coming afterward.

With respect to the example mentioned above, the previously described method for determining whether or not two transaction tracks are identical indicates that the two transaction tracks listed above are not identical. In addition, because the number of buyers sharing the “Seller 1, Seller 2” transaction track is greater than the preset number, the association established between Seller 1 and Seller is a unidirectional association. In other words, an association starts from Seller 1, listed first, and ends with Seller 2, listed second. However, because the number of buyers sharing the transaction track “Seller 2, Seller 1” is not greater than the preset number, a unidirectional association from Seller 2 to Seller 1 is not established.

Furthermore, when using this method to establish unidirectional associations among sellers, the method for making user recommendations based on the associations among sellers is also described. When presenting the seller's webpage, other sellers possessing a designated unidirectional association with the seller affiliated with the page are identified. This designated unidirectional association is a unidirectional association in the direction pointed to by the seller affiliated with the page. The other sellers are presented on the page.

With respect to the example mentioned above, when presenting the webpage of Seller 1, the designated unidirectional association is a unidirectional association in the direction pointed to by Seller 1. Therefore, it is determined that the other seller having this designated unidirectional association with Seller 1 is Seller 2, and Seller 2 is presented on the webpage of Seller 1. On the other hand, when presenting the webpage of Seller 2, the designated unidirectional association is a unidirectional association in the direction pointed to by Seller 2, and Seller 1 is not pointed to by Seller 2. Therefore, Seller 1 is not presented on the webpage of Seller 2.

When using this method to make user recommendations, it is possible to accurately predict the pages of other sellers that the buyer might browse after purchasing a product on the current seller's page. Therefore, the method further increases the accuracy of user recommendations.

In addition to being suitable for use in scenarios where the buyer's purchasing logic is unidirectional, this method of establishing unidirectional associations among sellers is also suitable for use in scenarios where the buyer's purchasing logic is bidirectional. For example, Buyer 1 purchased a three-dimensional (3D) television from Seller 1, and then purchased a 3D DVD player from Seller 2. Therefore, the transaction track for Buyer 1 is: Seller 1, Seller 2. The purchasing logic of Buyer 1 is: they purchased a 3D television, and only then wanted to purchase a 3D DVD player. Conversely, Buyer 2 purchased a 3D DVD player from Seller 2, and then purchased a 3D television from Seller 1. Therefore, the transaction track for Buyer 2 is: Seller 2, Seller 1. The purchasing logic of Buyer 2 is: they purchased a 3D DVD, and only then wanted to purchase a 3D television. In some embodiments, there might not be much difference in the number of buyers with Buyer 1's logic and Buyer 2's logic when purchasing products, and if the numbers for both of these types of transaction tracks are greater than the preset number, the server can establish a unidirectional association from Seller 1 toward Seller 2 and a unidirectional association from Seller 2 toward Seller 1. Therefore, when making user recommendations, Seller 2 is presented on Seller 1's page, and Seller 1 is presented on Seller 2's page.

In addition, in order to further increase the accuracy of user recommendations, it is possible to consider strength or degree of associability in associations, in addition to the directivity of associations. More specifically, the associations established in operation 104 may be defined as strong associations. That is, the associations established among sellers in the same transaction track are defined as strong associations. In addition, for two sellers that do not have a strong association, if at least one other seller has strong associations with both of these two sellers, a weak association can be established between these two sellers that are not strongly associated.

For example, for transaction tracks “Seller 1, Seller 3” and “Seller 1, Seller 4”, an association is established between Seller 1 and Seller 3, and an association is established between Seller 1 and Seller 4. The association between Seller 1 and Seller 3 and the association between Seller 1 and Seller 4 are defined as strong associations. Because Seller 1 has a strong association with both Seller 3 and Seller 4, a weak association is established between Seller 3 and Seller 4, which do not have a strong association.

After establishing these strong and weak associations, the user recommendation method may be implemented. When presenting the seller's webpage, it may be determined separately which sellers have strong associations and which sellers have weak associations with this seller. In addition, the sellers may be sorted according to the strong/weak order of the associations and are presented on the webpage. With respect to the example mentioned above, Seller 3 has a strong association with Seller 1 and a weak association with Seller 4. Therefore, when Seller 3's webpage is presented, Seller 1 and Seller 4 can be sorted as: Seller 1, Seller 4. That is, the seller with a strong association with Seller 3 comes first sequentially, and the seller with the weak association with Seller 3 comes second, and Seller 1 and Seller 4 are presented in order on the webpage of Seller 3.

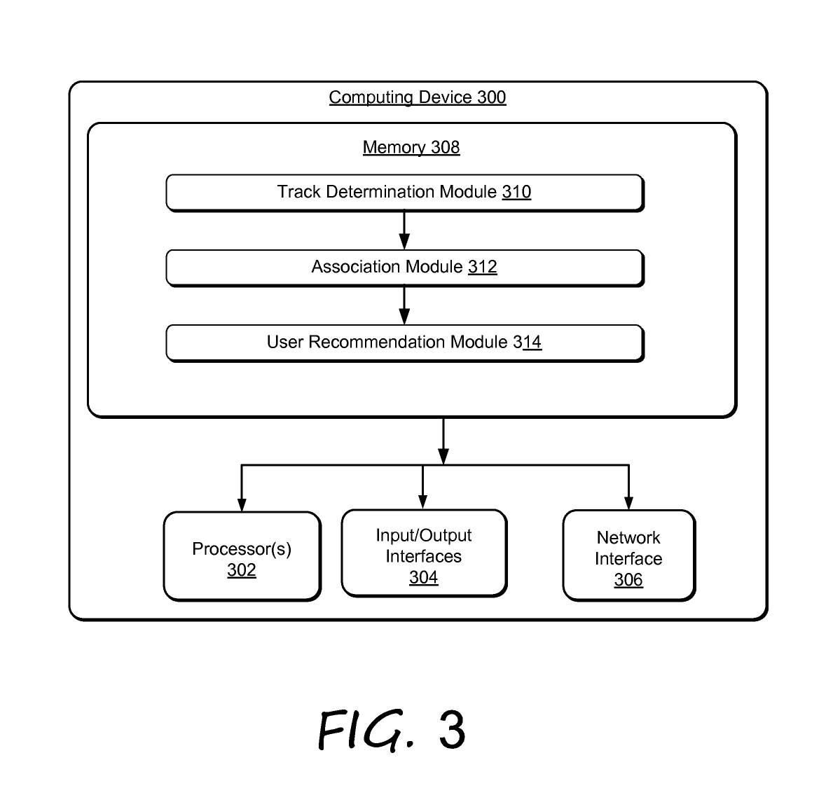

FIG. 3 is an example diagram of the user recommendation device presented by the embodiments of this disclosure. FIG. 3 illustrates an example of the computing device 300. The computing device 300 may be included in a server. In one exemplary configuration, the computing device 300 includes one or more processors 302, input/output interfaces 304, network interface 306, and memory 308.

The memory 308 may include computer-readable media in the form of volatile memory, such as random-access memory (RAM) and/or non-volatile memory, such as read only memory (ROM) or flash RAM. The memory 308 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

Turning to the memory 308 in more detail, the memory 308 may include a track determination module 310, an association module 312, and a user recommendation module 314.

The track determination module 310 may be configured to extract buyer transaction records. Based on the sequential order in which the records in the transaction record were generated, the track determination module 310 may sort the sellers from every record, and set the ordered sellers as a transaction track for the buyer.

The association module 312 may be configured to compare the transaction tracks of different buyers, find identical transaction tracks, and establish associations among the sellers included in identical transaction tracks. The user recommendation module 314 may be configured to make user recommendations based on the associations among sellers.

The track determination module 310 may implement a setting method to determine tracks, based on the ordered sellers, and all of the different tracks that can be determined using the setting method are viewed as all of the transaction tracks of the buyer. In some embodiments, two sellers are randomly extracted from the ordered sellers and, based on the ordering sequence of the two randomly extracted sellers in the set of ordered sellers; the two sellers are sorted, and then are set as a track.

The association module 312 may be configured to determine that two transaction tracks are identical transaction tracks when the sellers in one transaction track are the same as the sellers in the other transaction track. When the ordering sequences of the sellers in these two transaction tracks are the same, associations are established for the sellers in identical transaction tracks. In some embodiments, the association module 312 establishes unidirectional associations for the sellers in identical transaction tracks. In these instances, the unidirectional associations are associations of the seller coming first in the order toward the seller coming afterward.

The user recommendation module 314 may be configured to, when the seller's web page is presented, determine other sellers possessing a designated unidirectional association with the seller affiliated with the web page, and to present the other sellers on the web page. Here, the designated unidirectional association is a unidirectional association in the direction pointed to by the seller affiliated with the web page.

The association module 312 may be configured to also determine whether or not the number of buyers with identical transaction tracks is greater than a preset number, prior to establishing associations among the sellers included in identical transaction tracks.

The embodiments of this disclosure present a user recommendation method and device. This method sorts the sellers from every record according to the sequential order in which every record in the transaction record was generated, creates transaction tracks for the buyer, compares the transaction tracks of different buyers, determines identical transaction tracks, establishes associations among the sellers included in identical transaction tracks, and makes user recommendations based on the associations among sellers. Because identical transaction tracks for different buyers can indicate associability among different sellers in the actual transaction process, the server in the embodiments of this disclosure establishes associations for sellers based on identical tracks of different buyers rather than establishing associations based on information filled in by the sellers regarding the types of products sold. This approach can increase the accuracy of the associations among sellers established by the server, and can increase user recommendation accuracy and economize related processing resources.

A person skilled in the art may make a variety of alterations and modifications to this disclosure without departing from the spirit and scope of this disclosure. Thus, provided that the alterations and modifications made to this disclosure fall within the scope of the disclosure's claims and equivalent technologies, it is the intent of this disclosure to encompass these alterations and modifications.

What is claimed is:

1. A computer-implemented method for user recommendation, comprising:
extracting, by a server, transaction records of multiple buyers associated with multiple sellers;
sorting multiple sellers of each buyer from the transaction records based on a sequential order;
determining transaction tracks included in the sorted sellers of each buyer;
determining identical transaction tracks of the transaction tracks by comparing the transaction tracks of different buyer;
establishing associations among at least two sellers included in the identical transaction tracks; and
recommending a seller based on the associations.

2. The computer-implemented method of claim 1, wherein the determining transaction tracks included in the sorted sellers of each buyer comprises:
selecting two or more sellers from the sorted sellers of each buyer; and
designating the two or more sellers as a transaction tract of the buyer if existing an order of the two or more sellers in the sorted sellers.

3. The computer-implemented method of claim 1, wherein two transaction tracks are the identical transaction tracks if sellers of the two transaction tracks are identical and orders of the sellers in the two transaction track are identical.

4. The computer-implemented method of claim 1, wherein the establishing associations among the at least two sellers comprises:
establishing unidirectional associations for the at least two sellers, wherein the unidirectional associations are associations of a seller coming first in the order toward a seller coming afterward.

5. The computer-implemented method of claim 4, wherein the recommending the seller based on the associations comprises:
determining associated sellers based on the unidirectional associations related to the seller; and
recommending the associated sellers.

6. The computer-implemented method of claim 1, wherein the establishing the associations among the at least two sellers comprises establishing as the associations among the at least two sellers if a number of the associations is greater than a predetermined value.

7. A computing device comprising:
one or more processors; and
memory to maintain a plurality of components executable by the one or more processors, the plurality of components comprising:
a track determination module configured to:
extracting, by a server, transaction records of multiple buyers associated with multiple sellers;
sorting multiple sellers of each buyer from the transaction records based on a sequential order;
determining transaction tracks included in the sorted sellers of each buyer;
determining identical transaction tracks of the transaction tracks by comparing the transaction tracks of different buyer;
an association module configured to establish associations among at least two sellers included in the identical transaction tracks, and
a user recommendation module configured to recommend a seller based on the associations.

8. The computing device of claim 7, wherein the
determining transaction tracks included in the sorted sellers of each buyer comprises:
selecting two or more sellers from the sorted sellers of each buyer; and
designating the two or more sellers as a transaction tract of the buyer if existing an order of the two or more sellers in the sorted sellers.

9. The computing device of claim 7, wherein two transaction tracks are the identical transaction tracks if sellers of the two transaction tracks are identical and orders of the sellers in the two transaction track are identical.

10. The computing device of claim 7, wherein the establishing associations among the at least two sellers comprises:
establishing unidirectional associations for the at least two sellers, wherein the unidirectional associations are associations of a seller coming first in the order toward a seller coming afterward.

11. The computing device of claim 10, wherein the recommending the seller based on the associations comprises:
determining associated sellers based on the unidirectional associations related to the seller; and
recommending the associated sellers.

12. The computing device of claim 7, wherein the establishing the associations among the at least two sellers comprises establishing as the associations between or among the at least two sellers if a number of the associations is greater than a predetermined value.

13. One or more computer-readable media storing computer-executable instructions that, when executed by one or more processors, instruct the one or more processors to perform acts comprising:
extracting a transaction record including multiple transactions that multiple users conducts within a predetermined time period;
sorting multiple sellers associated with the multiple transactions of each user based on times that the transactions are conducted;
determining multiple transaction tracks based on the sorted multiple sellers; and
analyzing the multiple transaction tracks to establish an association of at least two sellers of the multiple sellers.

14. The one or more computer-readable media of claim 13, wherein the transaction record includes users behavior of the users, transactional times, and seller information that are associated with the multiple transactions.

15. The one or more computer-readable media of claim 13, where the transaction record is generated using sequential orders of the multiple transactions.

16. The one or more computer-readable media of claim 13, wherein the analyzing the multiple transaction tracks to generate the association of the at least two sellers of the multiple sellers comprises:
determining identical transaction tracks of the multiple transaction tracks;
calculating a number of the identical transaction tracks; and
establishing the association of the at least two sellers of the multiple sellers if the number of the identical transaction tracks is greater than a predetermined value.

17. The one or more computer-readable media of claim 16, wherein two transaction tracks are the identical transaction tracks when the transaction tracks include identical sellers and identical orders between or among the identical sellers.

18. The one or more computer-readable media of claim 13, wherein the acts further comprise:
identifying a seller associated with a transaction conducted by one user;
determining one or more sellers associated with the seller based on the established association; and
recommending the one or more sellers to the one user.

19. The one or more computer-readable media of claim 13, wherein the determining the one or more sellers associated with the seller based on the established association comprises determining the one or more sellers associated with the seller based on the established association and a degree of the established association.

20. The one or more computer-readable media of claim 13, wherein individual transaction track of the multiple transaction tracks indicates:
at least two transactions that the user conducted within the predetermined time period; and
a sequential order of the at least two transactions associated with at least two different sellers of the multiple sellers.
